(19) United States
(12) Patent Application Publication
(10) Pub. No.: US 2003/0202665 A1
(43) Pub. Date: Oct. 30, 2003

(54) Implementation method of 3D audio

(76) Inventors: Bo-Ting Lin, Miaoli Hsien (TW); Chi-Fon Wu, Taipei City (TW)

Correspondence Address: MERCHANT & GOULD P.C., P.O. BOX 2903, MINNEAPOLIS, MN, 55402-0903, US

(21) Appl. No.: 10/131,656

(22) Filed: Apr. 24, 2002

(51) Int. Cl. H04R 5/00

(52) U.S. Cl. 381/17; 381/1

(57) ABSTRACT

An implementation method of 3D audio, which uses Head-Related Transfer Function (HRTF) to synthesize binaural sound from a monaural source. The implementation method of 3D audio includes the step of establishing a monaural Head-Related Transform Function (HRTF) database and an Interaural Time Delay (ITD) compensation curve by operating a monaural HRTF measurement, which records a set of HRTF coefficients for one ear, so that an externally input monaural signal is converted into a 3D sound signal according to the monaural HRTF database and the ITD compensation curve.

### BACKGROUND OF THE INVENTION

1. Field of the Invention

This invention relates to an implementation method of 3D audio, and particularly to an implementation method of 3D audio using Head-Related Transfer Function (HRTF) technique to synthesize binaural sound from a monaural source.

2. Description of the Related Art

A typical surround sound system uses some simple delays and phase filters to mix left- and right-audio data to create a simulated 3D sound. However, this often causes distortion of the original sound due to the mixing process. Further, the typical surround sound cannot generate 3D sounds from front, back, up and down directions, especially when the listener is not located at the “sweet spot”. Accordingly, a system is described in which front and back sound location filters are employed and an electrical system is provided that permits panning from left to right through 180 degrees using the front filter and then from right to left through 180 degrees using the rear filter. According to the statistics derived from numerical analysis, scalers are provided at the filter inputs and/or outputs that adjust the range and location of the apparent sound source to eliminate, for example, ITD and IID (described later). However, this requires a large number of circuit components and filtering power in order to provide realistic sound placement.

Accordingly, an HRTF technique has been developed. The HRTF 3D technique provides a database obtained by measuring all frequency responses to two ears on each predetermined position in a 360 degrees measurement space, so as to synthesize 3D rendering by reference to the HRTF database.

FIG. 1 shows a typical HRTF measurement with 360 degrees. As shown in FIG. 1, a circle 10 with an artificial head 12 shown generally at the center of the circle 10 can be divided into 360 segments for assigning azimuth control parameters (360 degrees control). The location of a sound source can be smoothly panned from one segment to the next, so that the head 12 can perceive continuous movement of the sound source location. The segments are referenced or identified arbitrarily by various positions and, according to this HRTF measurement, position 0 is shown at 14 in alignment with the left ear of the head 12 and position 90 is shown at 16 directly in front of the head 12. Similarly, position 180 is at 18 aligned with the right ear of the head 12 and position 270 is at the rear of the head 12, as shown at point 20.

Because the azimuth position parameters wrap around at value 360, the positions 0 and 360 are equivalent at point 14. The range or apparent distance of the sound source is controlled by a range parameter. The distance scale is also divided into 360 segments with a value 0 corresponding to a position at the center of the head 12 and value 20 corresponding to a position at the perimeter of the head 12, which is assumed to be circular in the interest of simplifying the analysis. The range positions from 0-19 are represented at 22 and the remaining range positions 21 through 360 corresponding to positions outside of the head 12 as represented at 24. The maximum range of 360 is considered to be the limit of auditory space for a given implementation and, of course, can be adjusted based upon the particular implementation.

The aforecited configuration is set in an echoic chamber to perform the binaural measurement at each sound source of the 360 degrees (segments) coordinate space, so as to record the sound wave from 20 Hz to 20 KHz by the sampling rate at 48 or 44.1 KHz. Because the standard difference between two ears is about 20 cm (ranges 0-19) and causes the interaural time delay (ITD). Further, different personal heads, arms and shoulders cause other problems like the interaural intensity difference (IID). As such, the HRTF measurement to a single sound source has to be operated and recorded respectively on left and right ears. As such, the HRTF database is completed. However, it is well known that the physical effects of the diffraction of sound waves changed by the human torso, shoulders, head and outer ears will modify the spectrum of the sound that reaches the ear drums. These changes are represented by the HRTF, which varies in a complex way not only with azimuth, elevation, range and frequency but also different persons. As such, such an HRTF measurement will take much time.

### SUMMARY OF THE INVENTION

Therefore, an object of the invention is to provide an implementation method of 3D audio, which uses the HeadClient's Related Transfer Function (HRTF) to synthesize binaural sound from a monaural source.

Accordingly, the implementation method of 3D audio includes the step of establishing a monaural HRTF database and an ITD compensation curve by the monaural HRTF measurement so that an input monaural signal is converted into 3D sound according to the monaural HRTF database and the ITD compensation curve. The implementation method of 3D audio further includes adjusting an ITD model according to the ITD compensation curve. The implementation method of 3D audio further includes a head shadow effect by providing an adjustment kit to a user for setting the head shadow parameters to reach the 3D sound rendering.

### BRIEF DESCRIPTION OF THE DRAWINGS

FIG. 1 shows a diagram of a typical HRTF measurement with 360 degrees;

FIG. 2 shows a diagram of a monaural HRTF measurement of the invention;

FIG. 3 shows a diagram of a binaural synthesizing structure according to the invention;

FIG. 4 shows a graph of an ITD compensation curve used in ITD filter of FIG. 3 according to the invention; and

FIG. 5 is a flowchart of the operation of FIG. 3 according to the invention.

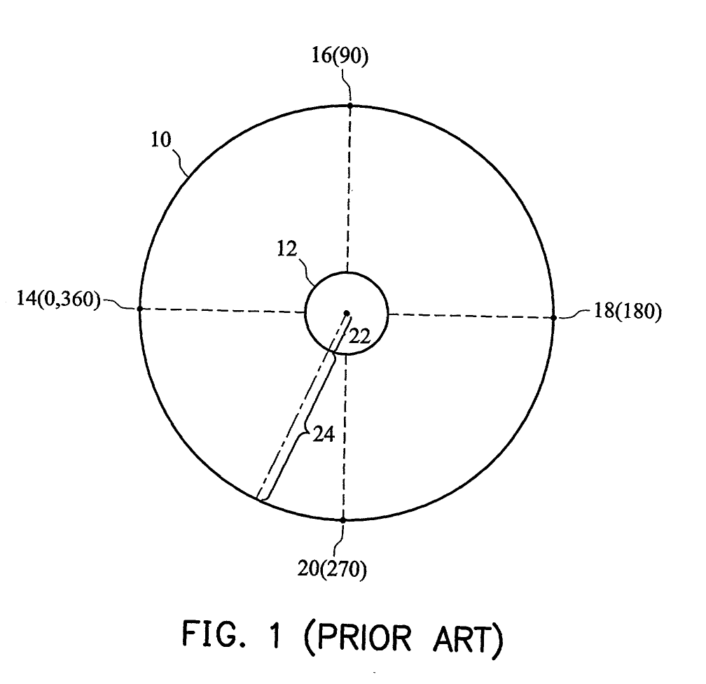

### DETAILED DESCRIPTION OF THE INVENTION

The following similar function elements are denoted by the same reference numerals.

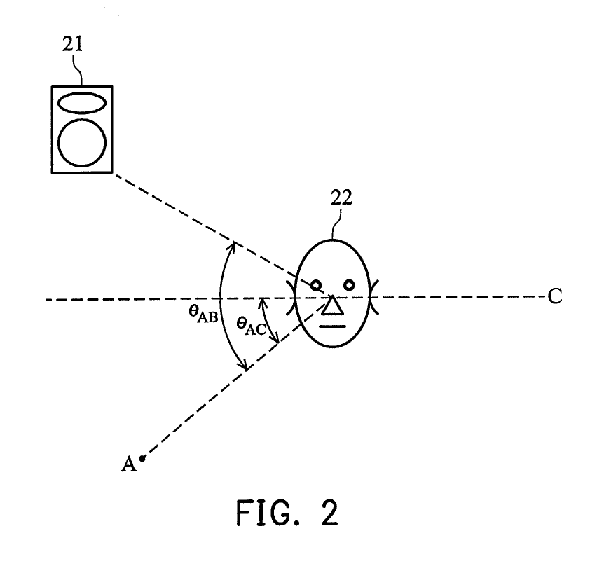

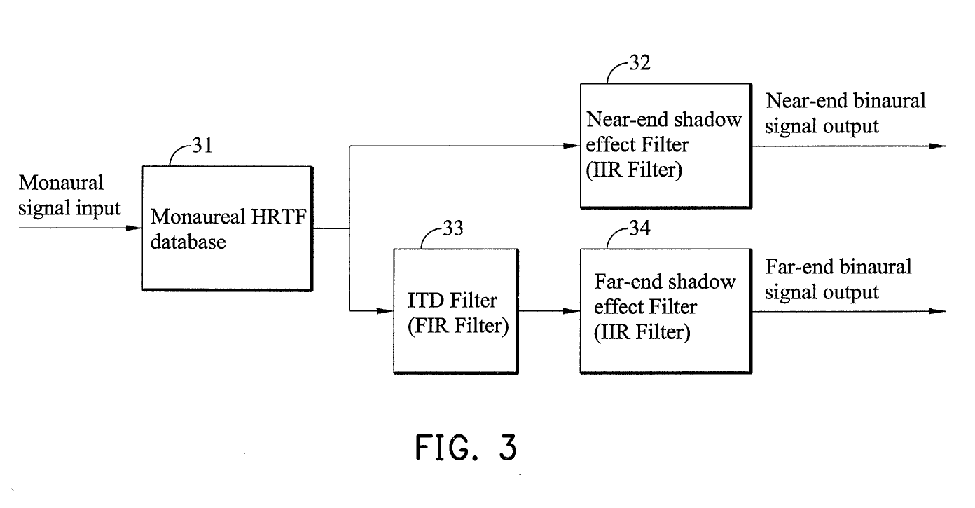

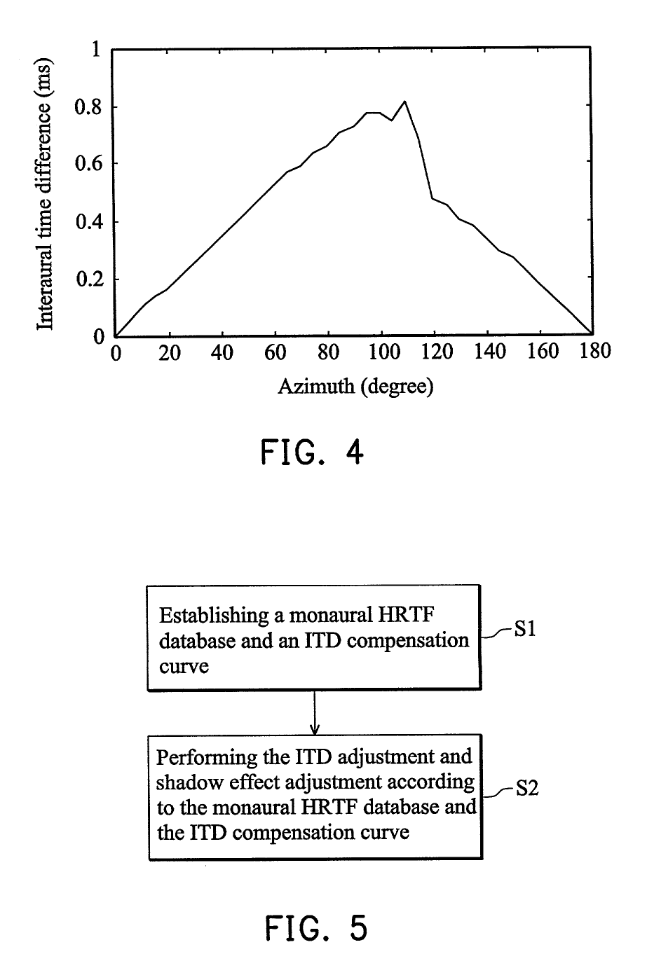

FIG. 2 shows a diagram of a monaural HRTF measurement of the invention. In FIG. 2, the monaural HRTF measurement only recorded left- or right-ear measurement data (a set of filter coefficients), different from the typical HRTF measurement having to individually record left- and right-ear measurement data. As shown in FIG. 2, a speaker 21 was located at 1.4 m from the left ear (functioning as a receiving microphone) of a head 22 to give the sound. By symmetry of human faces, only the half plane of HRTF was measured at a predetermined measurement position (for example, at the position A with predetermined azimuth angle θ_{AC} and elevation angle θ_{AB}) and recorded a set of filter coefficients, different from the measurement of the full plane of HRTF in the prior art. The transfer function (time domain) for the impulse response (frequency domain) recorded was found to complete an original HRTF database. Further, using a time equalizer (not shown) eliminated the effects of measurement equipment used like the speaker 21, the head 22 and the receiving microphone (the ear) from the original HRTF database and has obtained an updated HRTF database. For simplifying the implementation, after observing the result of performing the minimum phase transform to the transform function stored in the updated HRTF database, finding 32-tap FIR filter coefficients from the minimum phase transform was adapted to represent the required 3D sound simulation. As such, the desired monaural HRTF database included the 32-tap FIR filter coefficients and was implemented by a 32-tap FIR filter. However, with consideration of the practical application in personal differences, an ITD model 33 and near- and far-end shadow effects 32, 34 were applied in combination with the desired monaural HRTF database 31 as shown in FIG. 3. According to acoustical psychology, the near-end speaker's delay to left and right ears was omitted and only the far-end delay was compensated. FIG. 4 shows a graph of the ITD-to-azimuth curve at the elevation angle of 0 degree (i.e., at C axis of FIG. 2) of FIG. 3 according to the invention. As shown in FIG. 4, this curve was obtained by evaluating the cross correlation (represented by Gaussian function multiplying sine) respectively to the delays of the left- and right-ear transfer functions at a same measurement position (azimuth angle) and finding the maximum value from the evaluated result. The delay value corresponding to the maximum value is to be the desired ITD compensation reference value at this azimuth angle. With this regard, the resulting ITD compensation curve in FIG. 4 was implemented between the monaural HRTF database and far-end IIR filter by an ITD filter as shown in FIG. 3. Due to individual head profile differences, the near- and far-end shadow effect filters (IIR filters) were implemented, which provides an adjustment kit to a user for setting the head shadow parameters to reach the 3D sound rendering. The adjustment kit provides two parameter setting means to adjust the pole and zero values of each IIR filter to a significant 3D rendering to the user.

To summarize, an operation flowchart of FIG. 3 is shown in FIG. 5. The operation flowchart includes the steps: Establishing a monaural HRTF database and an ITD compensation curve (S1); and performing the ITD adjustment and the shadow effect adjustment according to the monaural HRTF database and the ITD compensation curve (S2). The monaural HRTF database established includes 32-tap FIR filter coefficients and can be implemented by a 32-tap FIR filter. However, the practical implementation can change the requirement with the need, not limited in 32-tap. The ITD compensation curve established presents approximately to a proportional constant in slope. Thus, the desired 3D rendering to a user can be easily reached by adjusting the ITD model and the far- and near-end head shadow effect filters (IIR filters) through the present configuration. Thus, the present method need not perform the HRTF measurement for individuals and/or change the entire filter coefficients.

Although the invention has been described in its preferred embodiment, it is not intended to limit the invention to the precise embodiment disclosed herein. Those who are skilled in this technology can still make various alterations and modifications without departing from the scope and spirit of this invention. Therefore, the scope of the invention shall be defined and protected by the following claims and their equivalents.

What is claimed is:

1. An implementation method of 3D audio, comprising the step of establishing a monaural Head-Related Transform Function (HRTF) database and an Interaural Time Delay (ITD) compensation curve by operating a monaural HRTF measurement, which records a set of HRTF coefficients for one ear, so that an externally input monaural signal is converted into a 3D sound signal according to the monaural HRTF database and the ITD compensation curve.

2. The implementation method of 3D audio of claim 1, wherein the establishing a monaural HRTF database includes Finite Impulse Response (FIR) filter coefficients and is implemented by a FIR filter.

3. The implementation method of 3D audio of claim 1, further comprising the step of adjusting the ITD model of the 3D sound signal according to the ITD compensation curve.

4. The implementation method of 3D audio of claim 1, further comprising the step of providing an adjustment kit to a user for setting head shadow parameters to reach the 3D sound rendering.

5. The implementation method of 3D audio of claim 4, wherein the head shadow parameters include Infinite Impulse Responses (IIRs).

6. An implementation method of 3D audio, comprising the steps:
establishing a monaural HRTF database and an ITD compensation curve by operating a monaural HRTF measurement, which records a set of filter coefficients for one ear;
separating an externally input monaural signal into a near-end binaural signal and a far-end binaural signal according to the monaural HRTF database;
adjusting an ITD model of the far-end binaural signal according to the monaural HRTF database and ITD compensation curve;
providing an adjustment kit to a user for setting head shadow parameters of the near-end binaural signal and the far-end binaural signal with the adjusted ITD model to reach the 3D sound rendering.

7. The implementation method of 3D audio of claim 6, wherein the establishing a monaural HRTF database includes Finite Impulse Response (FIR) filter coefficients and is implemented by a FIR filter.

8. The implementation method of 3D audio of claim 6, wherein the head shadow parameters include Infinite Impulse Responses (IIRs).
